(19) United States
(12) Patent Application Publication
(10) Pub. No.: US 2015/0151746 A1
(43) Pub. Date: Jun. 4, 2015

(54) VEHICLE BODY VIBRATION CONTROL DEVICE FOR VEHICLE

(71) Applicant: TOYOTA JIDOSHA KABUSHIKI KAISHA, Toyota-shi (JP)

(72) Inventor: Takashi SAITO, Fuji-shi (JP)

(73) Assignee: TOYOTA JIDOSHA KABUSHIKI KAISHA, Toyota-shi (JP)

(21) Appl. No.: 14/555,109

(22) Filed: Nov. 26, 2014

(30) Foreign Application Priority Data
Nov. 29, 2013 (JP) 2013-248604

(51) Int. Cl. B60W 30/02; B60W 50/06

(52) U.S. Cl. CPC B60W 30/025; B60W 50/06

(57) ABSTRACT

Provided is a vehicle body vibration control device (10) for a vehicle, including a request driving force calculation unit (20) calculating a driver's request driving force, a driving unit (16) applying a driving force to a vehicle (12), a driving force control unit (22) controlling the driving unit based on a command driving force, a notch filter (24) configured to receive a signal indicating the request driving force, process the signal so as to reduce a frequency component of vibration of a vehicle body, and output the processed signal to the driving force control unit as a signal indicating the command driving force. The device (10) further includes a notch filter control unit (26) configured to variably set the notch degree of the notch filter based on travelling parameters of the vehicle and correct the notch degree to a limit value when the notch degree exceeds the limit value.

### BACKGROUND OF THE INVENTION

1. Field of the Invention

The present invention relates to a vehicle body vibration control device for a vehicle such as an automobile, and more particularly, to a vehicle body vibration control device configured to suppress vibration of a vehicle body, which is caused by fluctuation in driving force of the vehicle.

2. Description of the Related Art

Vehicles such as automobiles travel by a driving force generated by a driving unit including a driving source such as an engine or an electric motor. Fluctuation in driving force generated from the driving unit causes loads to be applied on the vehicle body in a fore-and-aft direction and a vertical direction of the vehicle relative to wheels. Thus, pitching vibration occurs in the vehicle body. Therefore, it has been suggested that the pitching vibration of the vehicle body be reduced through appropriate control of a command driving force to the driving unit.

For example, Japanese Patent Application Laid-open No. 2007-237879 filed by the applicant of this application describes a vehicle body vibration control device configured based on the above-mentioned concept. This vehicle body vibration control device includes a request driving force calculation unit configured to calculate a driver's request driving force, a driving unit configured to apply a driving force to a vehicle, a driving force control unit configured to control the driving unit based on a command driving force, and a notch filter configured to receive a signal indicating the request driving force from the request driving force calculation unit. The notch filter has a notch frequency set to a value for reducing a frequency component of vibration of a vehicle body. The notch filter subjects the signal to filtering processing, and outputs the processed signal to the driving force control unit as a signal indicating the command driving force.

According to the vehicle body vibration control device of this type, the signal indicating the driver's request driving force is processed by the notch filter, and the driving unit is controlled based on the command driving force reduced in frequency component of the vibration of the vehicle body. As a result, the pitching vibration of the vehicle body can be reduced.

The effect of a notch filter to suppress vibration of a vehicle body varies according to the notch degree, i.e., the degree to reduce the component of the notch frequency. When the notch degree is set to a high value, although the effect of a notch filter to suppress vibration of a vehicle body is enhanced, the change in command driving force output to a drive unit is reduced, which increases the delay of the command driving force with respect to the request driving force.

An appropriate value of the notch degree of a notch filter varies according to the travelling situation of a vehicle. For that reason, it is contemplated to variably set the notch degree in accordance with the travelling situation of a vehicle by means of pre-setting a basic value of the notch degree to a constant value and correcting the basic value in accordance with the travelling situation of the vehicle.

For example, in the vehicle body vibration control device described in the above-mentioned Laid-open Publication, the notch degree is variably set so that as a vehicle speed is higher, an engine speed is higher, and a deceleration ratio is higher, the notch degree increases. In this configuration, as the parameters of the travelling situations of a vehicle for variably setting the notch degree are more in kind and number, the adaptability of the notch degree to the travelling situations of the vehicle can be enhanced.

It is to be noted that the parameters of the travelling situations of a vehicle include parameters of the driving state of the vehicle and parameters of the driving operations by a driver which are accompanied by the change in the vehicle driving force. The parameters of the driving state of the vehicle may be a vehicle speed, an engine speed and a deceleration ratio. The parameters of the driving operations by the driver may be an accelerator opening, shift position, the information of switches for selecting travelling mode and the like.

However, the parameters of the travelling situations of a vehicle for variably setting the notch degree are increased in kind and number, depending upon the combination of various travelling situations corresponding to the parameters, the notch degree may become excessively large or small. For example, when the proportion of the parameters that increase the notch degree relative to all the parameters is increased, the notch degree may become excessively large, which may increase the delay time of an actual driving force with respect to a request driving force. Conversely, when the proportion of the parameters that decrease the notch degree relative to all the parameters is increased, the notch degree may become excessively small, which may lead to lowering the effect to suppress vibration of a vehicle body.

### SUMMARY OF THE INVENTION

It is a main object of the present invention to prevent the notch degree becoming excessively large or small so that an actual driving force does not excessively delay with respect to a request driving force or the effect to suppess vibration of a vehicle body does not become insufficient, while ensuring the notch degree to be appropriate to the travelling situations of the vehicle as well as possible.

The present invention provides a vehicle body vibration control device for a vehicle, comprising: a request driving force calculation unit configured to calculate a request driving force of a driver; a driving unit configured to apply a driving force to the vehicle; a driving force control unit configured to control the driving unit based on a command driving force; and a notch filter configured to receive a signal indicating the request driving force from the request driving force calculation unit, subject the signal to filtering processing, and output the signal subjected to the filtering processing to the driving force control unit as a signal indicating the command driving force, the notch filter having a notch frequency set to a value for reducing a frequency component of vibration of a vehicle body. The vehicle body vibration control device comprises a notch filter control unit that variably sets the notch degree of the notch filter on the basis of a plurality of travelling parameters of the vehicle and corrects the notch degree to a limit value for limiting the variation range of the notch degree when the notch degree exceeds the limit value.

According to the above-mentioned configuration, the signal indicating the request driving force is processed by the notch filter having the notch frequency set to the value for reducing the frequency component of the vibration of the vehicle body, and the processed signal is output to the driving force control unit as the signal indicating the command driving force. Then, the notch degree of the notch filter is variably set by the notch filter control unit on the basis of a plurality of travelling parameters of the vehicle and the notch degree is corrected to a limit value for limiting the variation range of the notch degree when the notch degree exceeds the limit value.

Accordingly, as the notch degree is variably set on the basis of a plurality of travelling parameters, as compared to where the notch degree is set, for example, on the basis of a single travelling parameter, the adaptability of the notch degree to the travelling situations of a vehicle can be enhanced. On the other hand, when the notch degree is variably set on the basis of a plurality of travelling parameters, the variation range of the notch degree may extend. However, when the notch degree exceeds a limit value for limiting the variation range, the notch degree is corrected to the limit value. In consequence, it is possible to prevent the notch degree becoming excessively large or small so that an actual driving force does not excessively delay relative to a request driving force or the effect to suppress vibration of a vehicle body does not become insufficient, while ensuring the adaptability of the notch degree to the travelling situations of the vehicle as high as possible.

According to one embodiment of the present invention, in the above-mentioned configuration, the notch filter control unit may variably set a notch frequency of the notch filter on the basis of the vibration state of a vehicle body of the vehicle and the travelling states of the vehicle, and may variably set the limit value on the basis of the notch frequency so that as the notch frequency is lower, the limit value decreases.

In general, as the notch frequency is lower, the request driving force processed by the notch filter, i.e., the command driving force is more liable to unnecessarily vary, which lowers convergence and elongates the time that the command driving force requires to converge. In consequence, as the notch frequency is lower, the notch degree is preferably made smaller so that as the notch frequency is lower, the lowering in the convergence of the command driving force is more effectively restrained.

According to the above-mentioned configuration, the upper limit value is variably set on the basis of the notch frequency so that as the notch frequency is lower, the upper limit value decreases. As a result, as the notch frequency is lower, the limitation on the magnitude of the notch degree becomes severe, which makes it harder for the notch degree to increase and moderates the processing by the filter. Accordingly, as cored to where even the notch frequency becomes lower, the limitation on the magnitude of the notch degree is not made severe, a risk can be reduced that the command driving force unnecessarily varies, and it is possible to restrain a situation from occurring where as the notch frequency is lower, the command driving force lowers in convergence.

According to one embodiment of the present invention, in the above-mentioned configuration, the limit value may an upper limit value. According to this configuration, when the notch degree is larger than the upper limit value, the notch degree can be corrected to the upper limit value. Accordingly, a risk can be reduced that the notch degree becomes large enough to make the effect to suppress vibration excessive.

According to one embodiment of the present invention, in the above-mentioned configuration, the limit value may include upper and lower limit values, and the notch filter control unit may correct the notch degree to the upper limit value when the notch degree is larger than the upper limit value and may correct the notch degree to the lower limit value when the notch degree is smaller than the lower limit value.

According to the above-mentioned configuration, when the notch degree is larger than the upper limit value, the notch degree is corrected to the upper limit value and when the notch degree is smaller than the lower limit value, the notch degree is corrected to the lower limit value. Consequently, as compared to where the limit value is only an upper limit value, a risk can be reduced that the notch degree becomes excessively small, which makes the effect to suppress vibration insufficient. Conversely, as compared to where the limit value is only a lower limit value, a risk can be reduced that the notch degree becomes excessively large, which makes an actual driving force excessively delayed with respect to the associated request driving force.

Further, according to one embodiment of the present invention, in the above-mentioned configuration, the travelling parameters may be at least one of the parameters of the driving states of the vehicle and the parameters of the driving operations by the driver which are accompanied by the change in the vehicle driving force.

According to the above-mentioned configuration, the travelling parameters may be at least one of the parameters of the driving states of the vehicle and the parameters of the driving operations by the driver which are accompanied by the change in the vehicle driving force. Accordingly, the notch degree can be set in accordance with at least one of the parameters of the driving state of the vehicle and the parameters of the driving operations by the driver which are accompanied by the change in the vehicle driving force.

In particular, a plurality of travelling parameters are preferably parameters of the driving states of a vehicle and parameters of the driving operations. In the configuration, as compared to where a plurality of travelling parameters are a plurality of parameters of the driving state of a vehicle only or a plurality of parameters of the driving operations only, the adaptability of the notch degree to the travelling situations of a vehicle can be enhanced.

### BRIEF DESCRIPTION OF THE DRAWINGS

FIG. 1 is a block diagram illustrating a vehicle body vibration control device for a vehicle according to a first embodiment of the present invention, which is applied to a rear-wheel-drive vehicle including an engine and a transmission in combination as a driving unit.

FIG. 2 is a block diagram illustrating a notch filter control block according to the first embodiment of the present invention.

FIG. 3 is a graph showing an example of frequency characteristics of a notch filter, in other words, a relationship between a frequency and a gain.

FIG. 4 is a flowchart illustrating a notch degree control routine executed in the notch filter control block of an electronic control unit according to the first embodiment of the present invention.

FIG. 5 is a flowchart illustrating a notch degree limitation routine executed in the notch degree limitation block of the electronic control unit according to the first embodiment of the present invention.

FIG. 6 is a block diagram illustrating a notch filter control block in a vehicle body vibration control device for a vehicle according to the second embodiment of the present invention.

FIG. 7 is a flowchart illustrating a notch degree limitation routine executed in the notch degree limitation block in the second embodiment of the present invention.

FIG. 8 is a flowchart illustrating a first modification of the notch degree control routine.

FIG. 9 is a flowchart illustrating the principal part of a second modification of the notch degree control routine.

FIG. 10 is a map for calculating a driver's request driving force based on a vehicle speed and an accelerator opening.

### DETAILED DESCRIPTION OF THE PREFERRED EMBODIMENTS

Now, exemplary embodiments of the present invention are described in detail referring to the accompanying drawings.

### First Embodiment

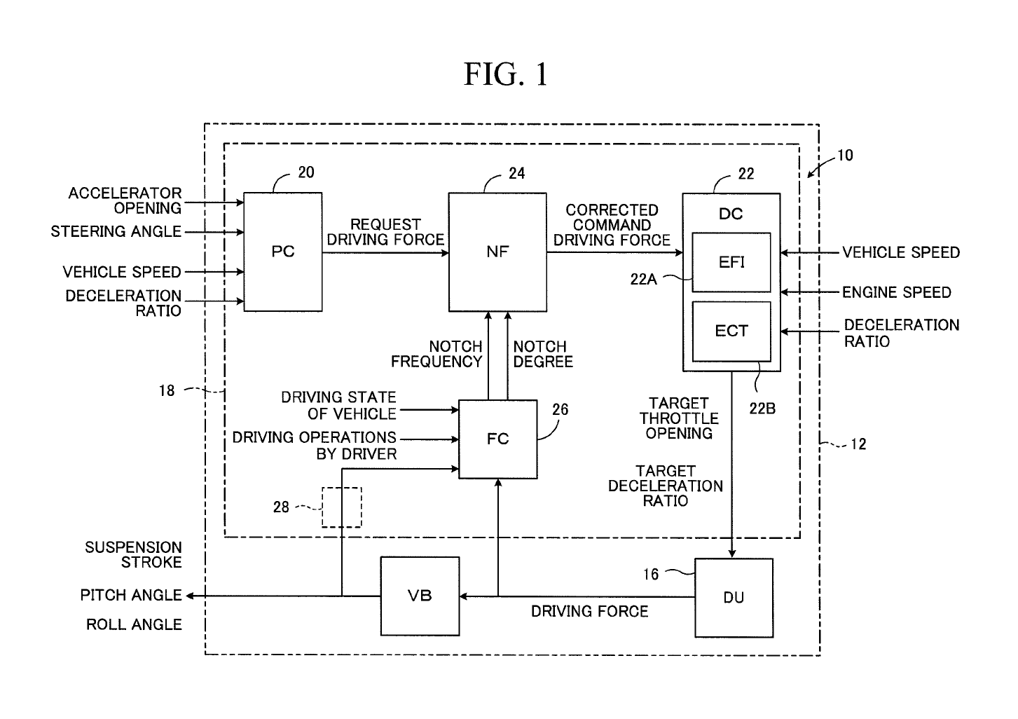

FIG. 1 is a block diagram illustrating a vehicle body vibration control device 10 for a vehicle according to a first embodiment of the present invention. In FIG. 1, the vehicle body vibration control device 10 is mounted on a vehicle 12, and includes a vehicle body (VB) 14, a driving unit (DU) 16 configured to apply a driving force to the vehicle 12 including the vehicle body 14, and an electronic control unit (ECU) 18 configured to control the driving unit 16. In the illustrated embodiment, the driving unit 16 includes an engine and a transmission (gear type automatic transmission, continuously variable transmission, or dual clutch transmission) in combination. However, the driving unit 16 may be another driving unit such as a hybrid system or an electric motor. The electronic control unit 18 may be an arbitrary electronic control unit having a calculation function and a storage function, for example, as in the case of a microcomputer.

The electronic control unit 18 includes a request driving force calculation block (PC) 20 configured to calculate a driver's request driving force, and a driving force control block (DC) 22 configured to output a signal for controlling a driving force to the driving unit 16. Signals indicating an accelerator opening degree and a steering angle, which correspond to a driver's steering operation amount, and signals indicating a vehicle speed and a decelerion ratio of the transmission, which correspond to parameters indicating a driving state of the vehicle, are input to the request driving force calculation block 20. The request driving force calculation block 20 calculates a driver's request driving force based on the accelerator opening degree, the steering angle, the vehicle speed, and the deceleration ratio, or another arbitrary driving force calculation input parameter in addition to those parameters.

A signal indicating the driver's request driving force is input to a notch filter (NF) 24. The notch filter 24 suppresses or blocks transmission of a notch frequency component among frequency components included in the signal indicating the request driving force to reduce the notch frequency component. In this case, the notch frequency is basically set to a resonance frequency of the vehicle body. The signal indicating the request driving force (command driving force) corrected through processing of the notch filter 24 is input to the driving force control block 22.

The driving force control block 22 includes an electronic fuel injection (EFI) system control unit 22A and an electronic control transmission (ECT) control unit 22B. The driving force control block 22 determines a target throttle opening degree and a target deceleration ratio based on the parameters of the command driving force, the vehicle speed, an engine speed, and a deceleration ratio, and the driving force control block 22 outputs signals indicating those target throttle opening and target deceleration ratio to the driving unit 16.

The engine is controlled based on the target throttle opening, and the transmission is controlled based on the target deceleration ratio. Accordingly, the driving unit 16 applies a driving force corresponding to the command driving force to the vehicle 12 including the vehicle body 14. When the driving force is applied to the vehicle 12 and fluctuates, the vehicle body 14 of the vehicle vibrates. In particular, vibration such as pitching vibration or rolling vibration of the vehicle body appears as a change in suspension stroke, pitch angle, or roll angle.

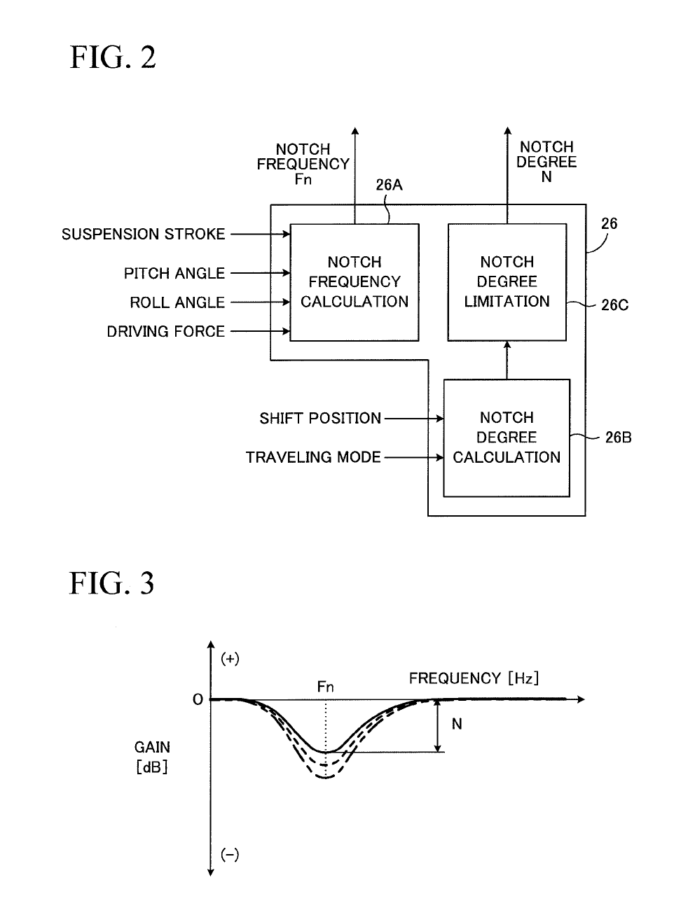

A signal indicating the driving force applied to the vehicle 12 by the driving unit 16, and a signal indicating the change in suspension stroke, pitch angle, or roll angle, which occurs in the vehicle body 14 due to the fluctuation of the driving force, are input to a notch filter control block (FC) 26. A signal indicating a shift position selected with a shift lever (not shown) operated by a driver is also input to the notch filter control block 26. Signals indicating a driving condition of the vehicle and the driving operations by the driver which are accompanied by the change in the vehicle driving force are also input to the notch filter control block 26. As illustrated in FIG. 2, the notch filter control block 26 includes a notch frequency calculation block 26A, a notch degree calculation block 26B, and a notch degree limitation block 26C.

The notch frequency calculation block 26A variably controls a notch frequency of the notch filter 24. Specifically, the notch frequency calculation block 26A calculates an amplitude distribution of pitching vibration or rolling vibration of the vehicle body with respect to a frequency of the command driving force on the basis of the correspondence between the frequency of the command driving force and vibration of the vehicle body 14, in particular, between the pitching vibration or the rolling vibration of the vehicle body. Then, the notch frequency calculation block 26A controls the notch frequency so as to minimize amplitude of the pitching vibration or the rolling vibration of the vehicle body.

For example, the notch frequency calculation block 26A performs frequency analysis by a Fourier transform method for response motion of the vehicle body to a driving force applied to the vehicle in various driving states of the vehicle. Then, the notch frequency calculation block 26A calculates an amplitude distribution of the pitching vibration or the rolling vibration of the vehicle body with respect to the frequency of the command driving force, and controls the notch frequency so as to minimize the amplitude thereof.

In this case, a signal indicating the pitching or the rolling of the vehicle body, which is input to the notch filter control block 26, may be subjected to low-pass filtering processing by a low-pass filter as indicated by a broken-line block 28 of FIG. 1. Through the low-pass filtering processing, vehicle body vibration of a relatively low frequency of about 1 Hz to 2 Hz, which is easily generated by resonance along with a change in driving operation amount such as the accelerator opening or the steering angle, is efficiently extracted. As a result, the notch frequency can be more accurately controlled.

The control itself of the notch frequency of the notch filter 24 is not a main subject of the present invention. Accordingly, the notch frequency may be calculated through an arbitrary procedure as long as the notch frequency is calculated to a value, for example, corresponding to a resonance frequency of the vehicle body so as to effectively reduce the pitching vibration or the rolling vibration of the vehicle body. For example, as another control procedure, a procedure described in paragraphs [0036] to of Japanese Patent Application Laid-open No. 2007-237879 filed by the applicant of this application may be used.

The notch degree calculation block 26B increasingly and decreasingly controls the notch degree of the notch filter 24, in other words, an attenuation degree of a component of the notch frequency. FIG. 3 shows frequency characteristics of the notch filter 24, in which Fn denotes a notch frequency. As can be understood from FIG. 3, a notch degree N indicates a depth of a V-shaped notch in the frequency characteristics. As the notch degree is higher, an attenuation degree of a driver's request driving force in the notch frequency is higher.

As illustrated in FIG. 2, the notch degree calculation block 26B variably sets the notch degree of the notch filter on the basis of at least one of the parameters of the driving state of the vehicle and the parameters of the driving operations by the driver which are accompanied by the change in the vehicle driving force. The parameters of the driving state of the vehicle may be a vehicle speed, an engine speed and a deceleration ratio. The parameters of the driving operations by the driver may be an accelerator opening, a shift position, the information of switches for selecting travelling mode and the like.

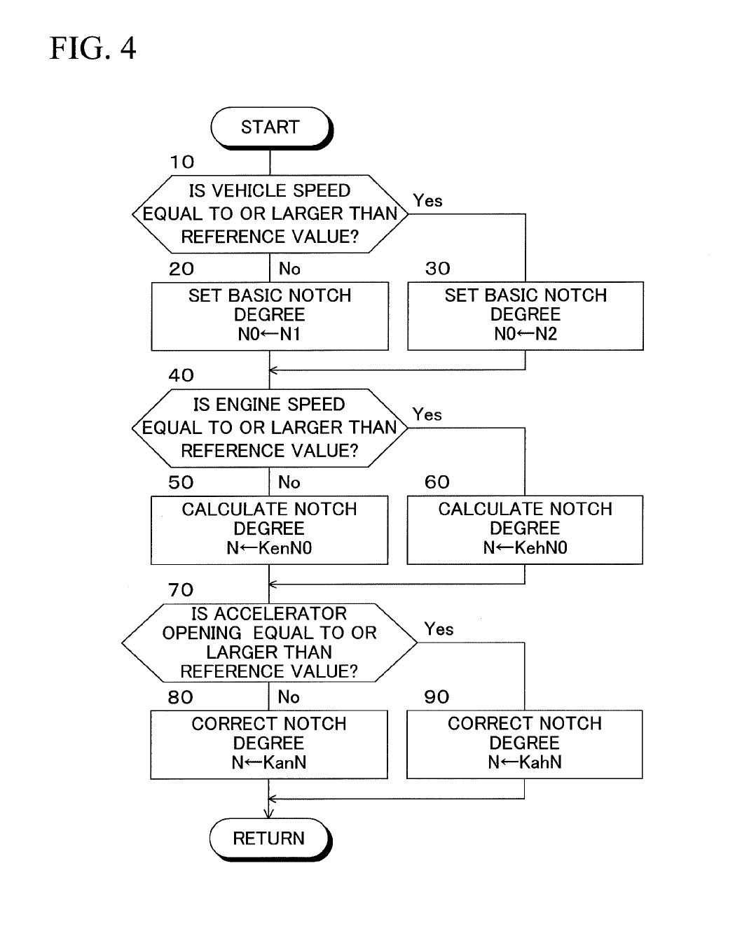

FIG. 4 is a flowchart illustrating an example of a notch degree calculation routine of the notch degree calculation block 26B. Control executed in accordance with the flowchart illustrated in FIG. 4 is started by turning ON an ignition switch (not shown), and is repeatedly executed at each predetermined time interval.

In Step 10, determination is made as to whether or not the vehicle speed is equal to or larger than a reference value for determining vehicle speed. When the determination is negative (NO), in Step 20, the basic notch degree N0 of the notch filter 24 is set to a standard value N1 (a positive constant). When the determination is positive (YES), in Step 30, the basic notch degree N0 is set to a value N2 for high vehicle speed (a positive constant that is smaller than the standard value N1).

In Step 40, determination is made as to whether or not the engine speed is equal to or larger than a reference value for determining engine speed. When the determination is negative (NO), in Step 50, the notch degree N of the notch filter 24 is calculated as a product Ken×N0 of a standard coefficient Ken (1 or a positive constant close to 1) and the basic notch degree N0. When the determination is positive (YES), in Step 60, the notch degree N of the notch filter 24 is calculated as the product KehN0 of a coefficient Keh for high engine speed (a positive constant larger than the standard coefficient Ken) and the basic notch degree N0.

In Step 70, determination is made as to whether or not the accelerator opening is equal to or larger than a reference value for determining accelerator opening. When the determination is negative (NO), in Step 80, the notch degree N of the notch filter 24 is corrected to a product Kan×N of a standard coefficient Kan (1 or a positive constant close to 1) and the notch degree N that was calculated in Step 50 or 60. When the determination is positive (YES), in Step 90, the notch degree N of the notch filter 24 is corrected to the product KahN0 of a coefficient Kah for high accelerator opening (a positive constant larger than the standard coefficient Kan) and the notch degree N that was calculated in Step 50 or 60.

As illustrated in FIG. 2, the notch degree limitation block 26C corrects, as necessary, the notch degree N calculated by the notch degree calculation block 26B so that the notch degree does not escape from the range between upper and lower limit values.

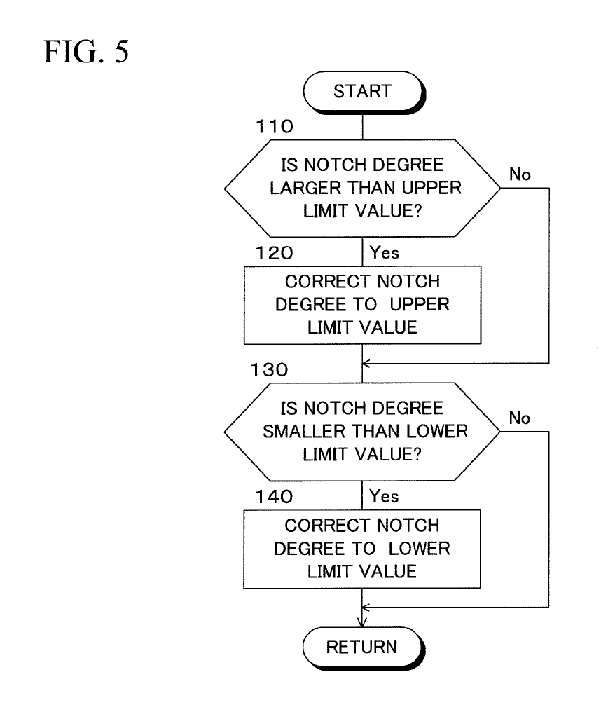

FIG. 5 is a flowchart illustrating an example of a notch degree limitation routine executed in the notch limitation calculation block 26C. Control executed in accordance with the flowchart illustrated in FIG. 5 is also started by turning ON an ignition switch (not shown), and is repeatedly executed at each predetermined time interval. In the description of the flowchart illustrated in FIG. 5, the control executed following the flowchart is simply referred to as control processing.

In Step 110, determination is made as to whether or not the notch degree N is larger than an upper limit value (a positive constant). When the determination is negative (NO), the control processing proceeds to Step 130. When the determination is positive (YES), in Step 120, the notch degree is corrected to the upper limit value and subsequently, the control processing proceeds to Step 130.

In Step 130, determination is made as to whether or not the notch degree N is smaller than an lower limit value (a positive constant that is smaller than the upper limit value). When the determination is negative (NO), the control processing is once terminated. When the determination is positive (YES), in Step 140, the notch degree is corrected to the lower limit value.

As apparent from the above description, the request driving force calculation block 20, the driving force control block 22, and the notch filter control block 26 respectively function as a request driving force calculation unit, a driving force control unit, and a notch filter control unit of the present invention. The functions of those blocks and the notch filter 24 are achieved under control of the electronic control unit 18. For example, each function is achieved by a calculation control unit such as a microcomputer constructing the electronic control unit 18 in accordance with a control program.

The notch degree N of the notch filter 24 calculated by the notch degree calculation block 26B is controlled so that the notch degree increases and decreases in accordance with a plurality of parameters among the various parameters of the driving state of the vehicle and the various parameters of the driving operations by the driver which are accompanied by the change in the vehicle driving force. In consequence, a risk can be reduced that the effect to suppress the vibration of the vehicle body is insufficient due to deficiency in the notch degree, or, conversely, the effect to suppress the vibration of the vehicle body is excessive due to the excess in the notch degree causing excessive delay of the actual driving force with respect to the request driving force. Accordingly, irrespective of the travelling conditions of the vehicle, the vehicle driving force can be controlled so as to achieve the effect to suppress the vibration of the vehicle body that is as high as possible while satisfying the driver's request for driving force.

In particular, the above-described embodiment is applied to a rear-wheel-drive vehicle. In consequence, nose-lift occurring when the request driving force increases can be reduced as effectively as possible and nose-dive occurring when the request driving force decreases can be reduced as effectively as possible, while satisfying the driver's request for driving force as well as possible.

As the number of parameters is larger, an increase/decrease range of the notch degree of the notch filter 24 may be larger with higher possibility. The notch degree is higher as the number of parameters for increasing the notch degree is larger. Conversely, the notch degree is lower as the number of parameters for decreasing the notch degree is larger. For example, in the example illustrated in FIG. 4, when negative determinations are made in all the Steps 10, 40 and 70, the notch degree N is set to a largest value. Conversely, when positive determination is made in all the Steps 10, 40 and 70, the notch degree N is set to a smallest value.

However, according to the first embodiment, a limit imposed by the notch degree limitation block 26C, i.e., the control executed following the flowchart shown in FIG. 5 enables prevention of the notch degree N from being set to an excessively large or small value exceeding the upper or lower limit value, respectively. Thus, the notch degree can be increased and decreased in accordance with the parameters of the driving states of the vehicle and the parameters of the driving operations by the driver which are accompanied by the change in the vehicle driving force, and prevented from being set to an excessively large or small value.

Accordingly, excessive correction of the driving force through the notch filter 24 due to an excessively large value of the notch degree can be prevented. As a result, vibration of the vehicle body can be reduced while preventing driver's unsatisfactory feeling as to the acceleration due to the deteriorated acceleration performance of the vehicle. Conversely, a shortage of correction of the driving force through the notch filer 24 due to an excessively small value of the notch degree can be similarly prevented. Thus, a driver's acceleration request can be satisfied while preventing a situation from occurring where the vibration of the vehicle body cannot be reduced.

### Second Embodiment

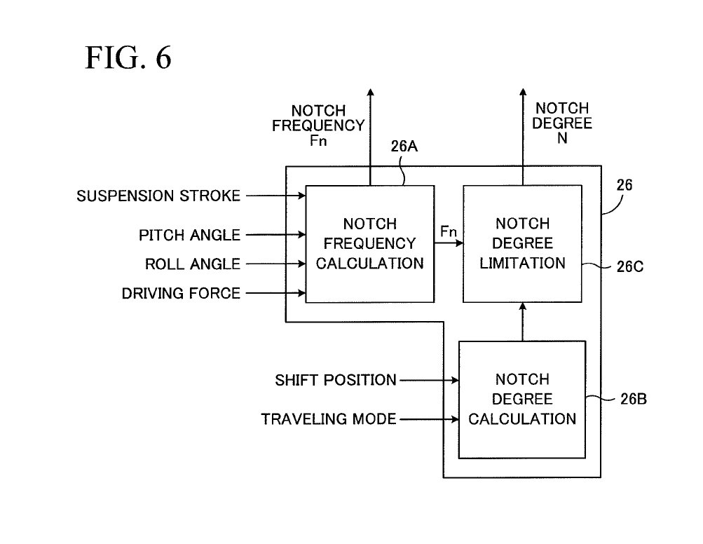

FIG. 6 is a block diagram, similar to FIG. 2, illustrating a notch degree control block in a vehicle body vibration control device for a vehicle according to the second embodiment of the present invention.

In the second embodiment, a signal indicating the notch frequency Fn is input to the notch degree limitation block 26C from the notch frequency calculation block 26A. The notch degree limitation block 26C variably sets an upper limit value for limiting the notch degree on the basis of the notch frequency Fn so that as the notch frequency is lower, the upper limit value is smaller.

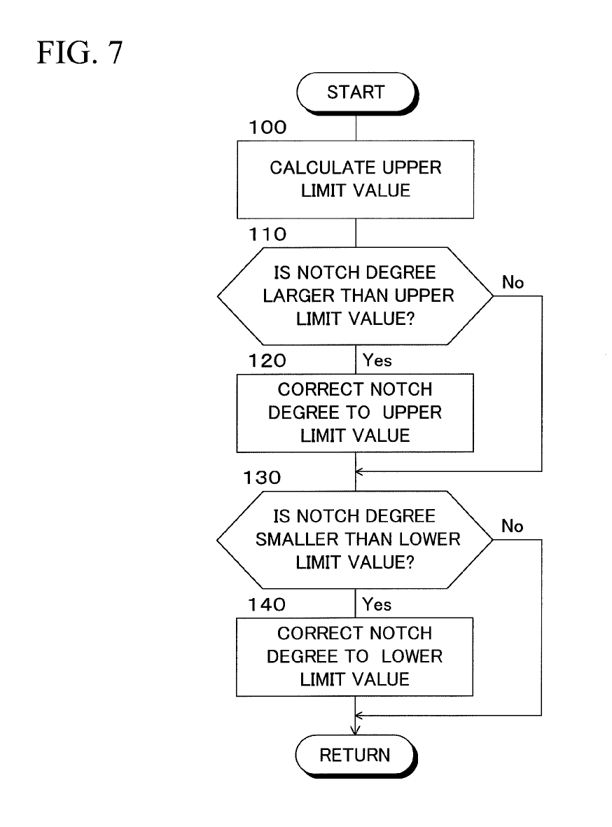

FIG. 7 is a flowchart, similar to FIG. 5, illustrating a notch degree limitation routine executed in the notch degree limitation block in the second embodiment of the present invention. It is to be noted that the notch degree N is calculated by following the flowchart shown in FIG. 4 similarly in the above-described first embodiment.

In the second embodiment, Step 100 is conducted prior to Step 110. In Step 100, a signal indicating the notch frequency Fn is read in from the notch frequency calculation block 26A and an upper limit value for limiting the notch degree is calculated on the basis of the notch frequency so that as the notch frequency Fn is lower, the upper limit value is smaller.

After completion of Step 100, except that the upper limit value utilized in Step 110 is not a preset constant value but the value calculated in Step 100, Steps 110-140 are executed in the same manner as in the above-described first embodiment.

As described above, as the notch frequency Fn is lower, the request driving force corrected by the notch filer 24, i.e., the command driving force is more liable to unnecessarily vary, which lowers convergence and elongates the time that the command driving force requires to converge. In consequence, as the notch frequency Fn is lower, the notch degree is preferably made smaller so that as the notch frequency is lower, the lowering in the convergence of the command driving force is more effectively restrained.

According to the second embodiment, the magnitude of the notch degree is limited utilizing the upper limit value that is calculated so that as the notch frequency Fn is lower, the upper limit value decreases. As a result, as the notch frequency Fn is lower, the limitation on the magnitude of the notch degree becomes severe, which makes it harder for the notch degree to increase. Accordingly, in addition to the same preferable advantageous effect as in the first embodiment being obtained, a risk can be reduced that the command driving force unnecessarily varies, and it is possible to restrain a situation from occurring where as the notch frequency is lower, the command driving force lowers in convergence.

The specific embodiments of the present invention are described in detail above. However, the present invention is not limited to the above-mentioned embodiments. It is apparent for those skilled in the art that various other embodiments may be employed within the scope of the present invention.

For example, in the above-mentioned embodiments, the notch degree N of the notch filter 24 is calculated on the basis of a vehicle speed, an engine speed and an accelerator opening. However, the parameters for calculating the notch degree may be an arbitrary plurality of parameters so long as they are plurality of parameters including at least one of the parameters of the driving states of the vehicle and the parameters of the driving operations by the driver which are accompanied by the change in the vehicle driving force.

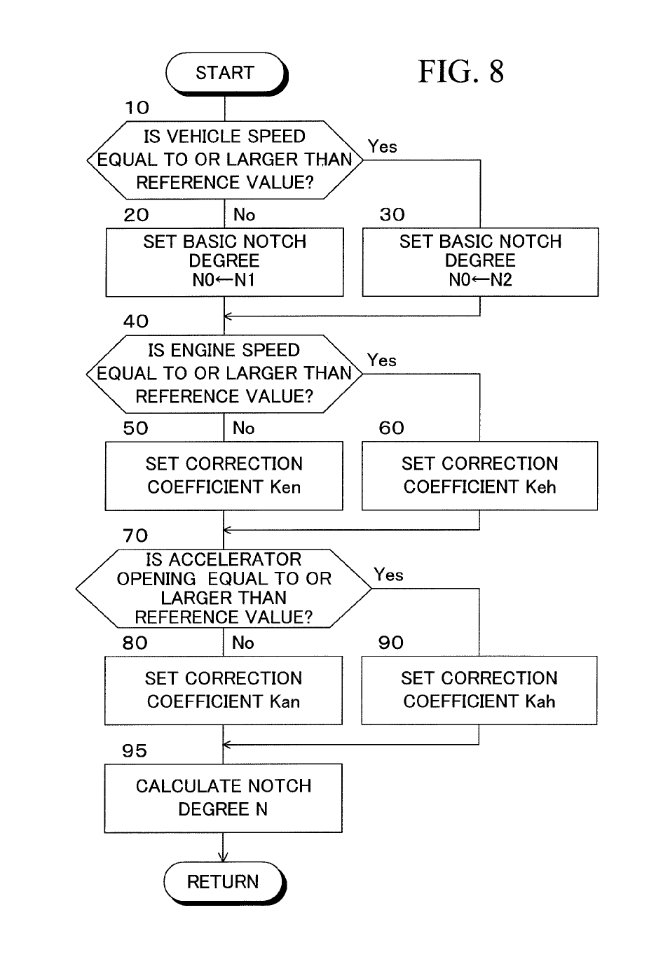

In the above-mentioned embodiments, the basic notch degree N0 is calculated on the basis of a vehicle speed; the notch degree N is calculated on the basis of an engine speed; and the notch degree N is corrected on the basis of an accelerator opening. However, as illustrated in FIG. 8 as a first modification, for example, the basic notch degree N0 may be calculated on the basis of a certain parameter; correction coefficients may be calculated on the basis of the other plurality of parameters; and the notch degree may be calculated as a product of the basic notch degree N0 and the plurality of the correction coefficients (Step 95).

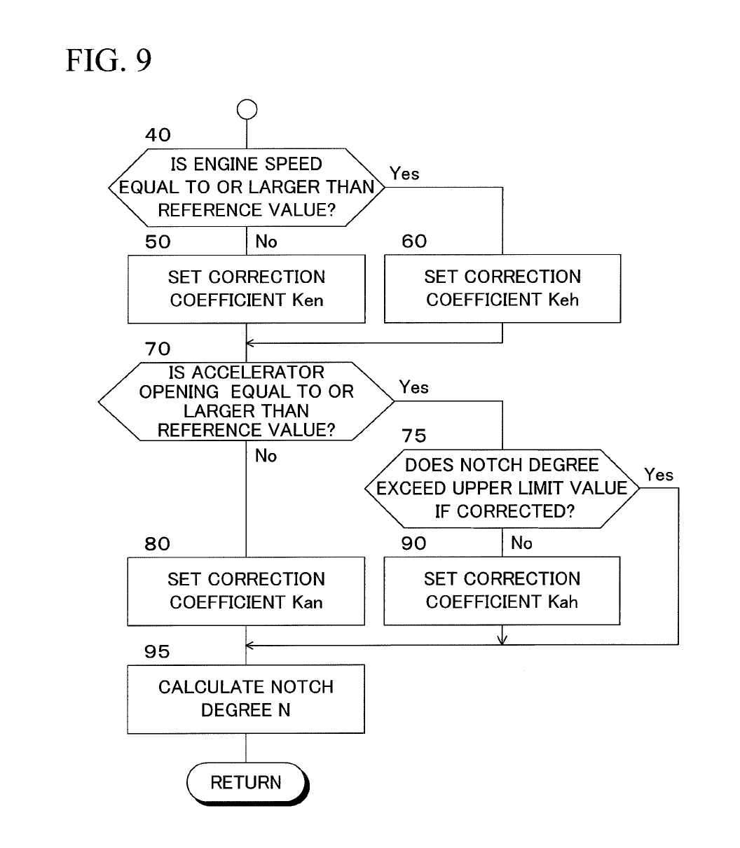

In the above-mentioned embodiments, the notch degree is prevented from exceeding the limit value by the limitation routine for the notch degree illustrated in FIG. 5 or 7. However, as illustrated in FIG. 9 as a second modification, for example, determination may be made whether or not the notch degree exceeds the limit value if it is multiplied by the correction coefficient, and when the notch degree multiplied by the correction coefficient is determined to exceed the limit value, multiplication by the correction coefficient may not be conducted. In the second modification, it is not necessary to prevent the notch degree from exceeding the limit value by the limitation routine for the notch degree illustrated in FIG. 5 or 7. It is to be noted that when the notch degree multiplied by the correction coefficient is determined to exceed the limit value, the notch degree may be multiplied by a value smaller than the correction coefficient so as not to exceed the limit value.

In the above-mentioned embodiments, the limit value for limiting the varying range of the notch degree includes the upper and lower limit values and the varying range is limited by the upper and lower limit values. However, one of the limitation of the varying range of the notch degree by the upper and lower limit values may be omitted.

In particular, in the above-mentioned second embodiment, only the upper limit value is variably set on the basis of the notch frequency of the notch filter so that as the notch frequency is lower, the upper limit value is lower. However, the lower limit value may also variably be set on the basis of the notch frequency of the notch filter so that as the notch frequency is lower, the lower limit value is lower.

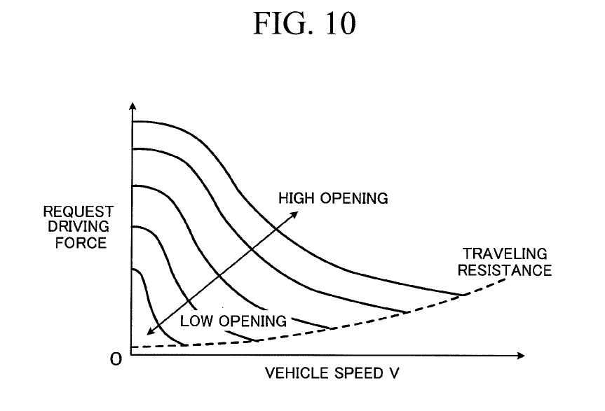

In the above-mentioned embodiments, the driver's request driving force is estimated based on the accelerator opening. However, correction may be performed in such a manner that the driver's request driving force is calculated from a map illustrated in FIG. 10 based on the vehicle speed and the accelerator opening. In FIG. 10, a high opening and a low opening respectively mean a large accelerator opening and a small accelerator opening.

In the above-mentioned embodiments, the driving unit 16 includes the engine and the transmission in combination, and signals indicating a target throttle opening and a target deceleration ratio calculated based on the command driving force or the like are output to the driving unit 16. However, when the vehicle body vibration control device of the present invention is applied to a vehicle having a hybrid system mounted thereon, outputs of an engine and an electric motor may be controlled based on the command driving force or the like. When the vehicle body vibration control device of the present invention is applied to an electric vehicle, an output of an electric motor may be controlled based on the command driving force or the like.

In particular, when the vehicle body vibration control device of the present invention is applied to the vehicle having a hybrid system mounted thereon or to the electric vehicle, torque of the electric motor is lowered along with increase of the revolution speed thereof, and thus the notch degree may be set lower as the vehicle speed is higher.

In the above-mentioned embodiments, the vehicle is the rear-wheel-drive vehicle. However, the vehicle body vibration control device of the present invention may be applied to a front-wheel-drive vehicle and a four-wheel-drive vehicle.

1. A vehicle body vibration control device for a vehicle, comprising:
a request driving force calculation unit configured to calculate a request driving force of a driver;
a driving unit configured to apply a driving force to the vehicle;
a driving force control unit configured to control said driving unit based on a command driving force; and
a notch filter configured to receive a signal indicating the request driving force from said request driving force calculation unit, subject the signal to filtering processing, and output the signal subjected to the filtering processing to said driving force control unit as a signal indicating the command driving force, said notch filter having a notch frequency set to a value for reducing a frequency component of vibration of a vehicle body,
wherein said vehicle body vibration control device comprises a notch filter control unit that variably sets the notch degree of said notch filter on the basis of a plurality of travelling parameters of the vehicle and corrects the notch degree to a limit value for limiting the variation range of the notch degree when the notch degree exceeds said limit value.

2. A vehicle body vibration control device for a vehicle according to claim 1, wherein said notch filter control unit variably sets a notch frequency of said notch filter on the basis of the vibration state of a vehicle body of the vehicle and the travelling states of the vehicle, and variably sets said limit value on the basis of the notch frequency so that as the notch frequency is lower, said limit value decreases.

3. A vehicle body vibration control device for a vehicle according to claim 2, wherein said limit value is an upper limit value.

4. A vehicle body vibration control device for a vehicle according to claim 1, wherein said limit value includes upper and lower limit values, and said notch filter control unit corrects the notch degree to said upper limit value when the notch degree is larger than said upper limit value and corrects the notch degree to said lower limit value when the notch degree is smaller than said lower limit value.

5. A vehicle body vibration control device for a vehicle according to claim 1, wherein said travelling parameters are at least one of the parameters of the driving stated of the vehicle and the parameters of the driving operations by the driver which are accompanied by the change in the vehicle driving force.

6. A vehicle body vibration control device for a vehicle according to claim 2, wherein said limit value includes upper and lower limit values, and said notch filter control unit corrects the notch degree to said upper limit value when the notch degree is larger than said upper limit value and corrects the notch degree to said lower limit value when the notch degree is smaller than said lower limit value.

7. A vehicle body vibration control device for a vehicle according to claim 2, wherein said travelling parameters are at least one of the parameters of the driving stated of the vehicle and the parameters of the driving operations by the driver which are accompanied by the change in the vehicle driving force.

8. A vehicle body vibration control device for a vehicle according to claim 3, wherein said travelling parameters are at least one of the parameters of the driving stated of the vehicle and the parameters of the driving operations by the driver which are accompanied by the change in the vehicle driving force.

9. A vehicle body vibration control device for a vehicle according to claim 4, wherein said travelling parameters are at least one of the parameters of the driving stated of the vehicle and the parameters of the driving operations by the driver which are accompanied by the change in the vehicle driving force.
